(19) United States
(12) Patent Application Publication
(10) Pub. No.: US 2026/0018098 A1
(43) Pub. Date: Jan. 15, 2026

(54) DISPLAY APPARATUS, PICTURE ADJUSTMENT METHOD, AND DEVICE

(71) Applicant: HUAWEI TECHNOLOGIES CO., LTD., Shenzhen (CN)

(72) Inventors: Kun Luo, Shenzhen (CN); Congbiao Jiang, Shenzhen (CN)

(73) Assignee: HUAWEI TECHNOLOGIES CO., LTD., Shenzhen (CN)

(21) Appl. No.: 19/333,775

(22) Filed: Sep. 19, 2025

Related U.S. Application Data
(63) Continuation of application No. PCT/CN2024/070616, filed on Jan. 4, 2024.

(30) Foreign Application Priority Data
Mar. 22, 2023 (CN) 202310311213.5

(51) Int. Cl. G09G 3/20; G09G 3/32

(52) U.S. Cl. CPC G09G 3/2007; G09G 3/32; G09G 2320/0242; G09G 2360/16

(57) ABSTRACT

A display apparatus, a picture adjustment method, and a device are disclosed. The display apparatus includes a display panel, a control module, a gamma module, a current source module, and a pulse width modulation (PWM) module. The control module sends a present temperature value, a present current value, and a present brightness value to the gamma module. The gamma module determines a target current value based on the present current value and the present temperature value, and sends the target current value to the current source module. The gamma module determines a present grayscale value based on the present temperature value and the present brightness value. The gamma module determines a target grayscale value based on the present grayscale value and the present temperature value, and sends the target grayscale value to the PWM module.

### CROSS-REFERENCE TO RELATED APPLICATIONS

This application is a continuation of International Application No. PCT/CN2024/070616, filed on Jan. 4, 2024, which claims priority to Chinese Patent Application No. 202310311213.5, filed on Mar. 22, 2023. The disclosures of the aforementioned applications are hereby incorporated by reference in their entireties.

### TECHNICAL FIELD

This application relates to the field of display technologies, and in particular, to a display apparatus, a picture adjustment method, and a device.

### BACKGROUND

Currently, compared with a conventional liquid crystal display (LCD) and an inorganic gallium nitride and gallium phosphide light-emitting diode display, a micro light-emitting diode (Micro LED) display has advantages such as high contrast, high brightness, a wide color gamut, and a high refresh rate. In addition, compared with an organic light-emitting diode (AMOLED) display, the micro LED display has advantages such as high brightness and a long service life. Therefore, the micro LED display is considered as an ultimate display technology, and may be used in a plurality of display forms such as a large-screen television, a medium-sized laptop computer, a monitor, a small-sized mobile phone, and micro-sized augmented reality and virtual reality display.

However, due to ordered arrangement of crystal of an inorganic material, lattice constants of different types of crystal structures are different, resulting in a crystal stress, namely, a lattice stress. Under impact of the lattice stress, a larger drive current indicates a blue shift of a light emission peak of the LED, that is, movement of a light emission wavelength of the LED toward a short wavelength direction; and a higher temperature indicates a red shift of the light emission peak of the LED, that is, movement of the light emission wavelength of the LED toward a long wavelength direction. Further, the light emission peak of the LED changes with the drive current and the temperature, resulting in a large color temperature change of color displaying, and affecting viewing experience of a user.

Therefore, how to reduce the color temperature change and improve display picture consistency is an urgent problem to be resolved currently.

### SUMMARY

This application provides a display apparatus, a picture adjustment method, and a device, to resolve a problem of a large color temperature change of a display picture.

According to a first aspect, an embodiment of this application provides a display apparatus. The display apparatus includes a display panel, a control module, a gamma module, a current source module, and a pulse width modulation PWM module.

The control module is configured to send panel information of the display panel to the gamma module, where the panel information includes a present temperature value, a present current value, and a present brightness value.

The gamma module is configured to: calculate a target current value based on the present current value and the present temperature value, and send the target current value to the current source module; determine a present grayscale value based on the present temperature value and the present brightness value; and calculate a target grayscale value based on the present grayscale value and the present temperature value, and send the target grayscale value to the PWM module.

The current source module is configured to output a current to the display panel based on the target current value.

The PWM module is configured to output a PWM signal to the display panel based on the target grayscale value.

A color temperature change of a display picture mainly includes two aspects: a color temperature change caused by a brightness change of the display picture, and a color temperature change caused by a light emission wavelength change of a light-emitting diode. The light emission wavelength change is mainly caused by a crystal stress between different types of crystal structures. Under impact of the crystal stress, a larger drive current indicates a blue shift of a light emission peak of the LED, that is, movement of a light emission wavelength of the LED toward a short wavelength direction; and a higher temperature indicates a red shift of the light emission peak of the LED, that is, movement of the light emission wavelength of the LED toward a long wavelength direction.

Based on the foregoing technical solution, the display apparatus may calculate the target current value based on the present current value and the present temperature value of the display panel, calculate the target grayscale value based on the present temperature value and the present grayscale value, and further correct the grayscale by adjusting a duty cycle based on the PWM signal, to maintain stable brightness of the display picture and reduce impact of a temperature change on the brightness of the picture; and correct a wavelength by driving light emitting of the light-emitting diode via a current, to maintain stability of the light emission wavelength and reduce impact of the temperature change on the light emission wavelength. In conclusion, the solution can mitigate a color cast phenomenon of the display panel caused by the temperature change, namely, a color temperature change phenomenon, and improve display picture consistency.

In a possible implementation, the control module is further configured to:
send a first correction instruction to the gamma module, to instruct to perform compensation correction or gain correction on the present current value of the display panel; and
the gamma module is specifically configured to:
if the first correction instruction instructs to perform compensation correction on the present current value of the display panel, calculate a target current compensation value based on the present temperature value and a preset linear function relationship between a temperature value and a current compensation value, and add the present current value to the target current compensation value to obtain the target current value; or
if the first correction instruction instructs to perform gain correction on the present current value of the display panel, calculate a target current gain value based on the present temperature value and a preset linear function relationship between a temperature value and a current compensation value, and multiply the present current value by the target current gain value to obtain the target current value.

Based on the foregoing technical solution, adjustment of the drive current of the display panel may approach linear adjustment, to further improve a wavelength change caused by the temperature change. In addition, in this solution, gain correction or compensation correction may further be performed on the drive current of the display panel based on an actual requirement of a user, to make a correction operation flexible and convenient.

In a possible implementation, the control module is further configured to:
send a second correction instruction to the gamma module, to instruct to perform compensation correction or gain correction on the present grayscale value of the display panel; and
the gamma module is specifically configured to:

if the second correction instruction instructs to perform compensation correction on the present grayscale value of the display panel, calculate a target grayscale compensation value based on the present temperature value and a preset linear function relationship between a temperature value and a grayscale compensation value, and add the present grayscale value to the target grayscale compensation value to obtain the target grayscale value; or
if the second correction instruction instructs to perform gain correction on the present grayscale value of the display panel, calculate a target grayscale gain value based on the present temperature value and a preset linear function relationship between a temperature value and a grayscale gain value, and multiply the present grayscale value by the target grayscale gain value to obtain the target grayscale value.

Based on the foregoing technical solution, adjustment of the display grayscale of the display panel may approach linear adjustment, to improve a brightness change caused by the temperature change. In addition, in this solution, gain correction or compensation correction may further be performed on the display grayscale of the display panel based on an actual requirement of a user, to make a correction operation flexible and convenient.

In a possible implementation, the gamma module is specifically configured to:
determine the present grayscale value based on the present temperature value, the present brightness value, and a preset lookup table, where the lookup table represents a correspondence between a temperature value, a brightness value, and a grayscale value.

In this design, the gamma module may quickly determine, through table lookup, the present grayscale value corresponding to the present temperature value and the present brightness value.

According to a second aspect, an embodiment of this application further provides a picture adjustment method, applied to a display apparatus. The display apparatus includes a display panel, a control module, a gamma module, a current source module, and a PWM module. The method includes the following steps:

The control module sends panel information of the display panel to the gamma module, where the panel information includes a present temperature value, a present current value, and a present brightness value;
the gamma module calculates a target current value based on the present current value and the present temperature value, and sends the target current value to the current source module;
the gamma module determines a present grayscale value based on the present temperature value and the present brightness value;
the gamma module calculates a target grayscale value based on the present grayscale value and the present temperature value, and sends the target grayscale value to the PWM module;
the current source module outputs a current to the display panel based on the target current value; and
the PWM module outputs a PWM signal to the display panel based on the target grayscale value.

In a possible implementation, the method further includes the following step:

The control module sends a first correction instruction to the gamma module, to instruct to perform compensation correction or gain correction on the present current value of the display panel.

That the gamma module calculates the target current value based on the present current value and the present temperature value includes the following steps:
If the first correction instruction instructs to perform compensation correction on the present current value of the display panel, the gamma module calculates a target current compensation value based on the present temperature value and a preset linear function relationship between a temperature value and a current compensation value, and adds the present current value to the target current compensation value to obtain the target current value; or
if the first correction instruction instructs to perform gain correction on the present current value of the display panel, the gamma module calculates a target current gain value based on the present temperature value and a preset linear function relationship between a temperature value and a current compensation value, and multiplies the present current value by the target current gain value to obtain the target current value.

In a possible implementation, the method further includes the following steps:

The control module sends a second correction instruction to the gamma module, to instruct to perform compensation correction or gain correction on the present grayscale value of the display panel; and
if the second correction instruction instructs to perform compensation correction on the present grayscale value of the display panel, the gamma module calculates a target grayscale compensation value based on the present temperature value and a preset linear function relationship between a temperature value and a grayscale compensation value, and adds the present grayscale value to the target grayscale compensation value to obtain the target grayscale value; or
if the second correction instruction instructs to perform gain correction on the present grayscale value of the display panel, the gamma module calculates a target grayscale gain value based on the present temperature value and a preset linear function relationship between a temperature value and a grayscale gain value, and multiplies the present grayscale value by the target grayscale gain value to obtain the target grayscale value.

In a possible implementation, the determining the present grayscale value based on the present temperature value and the present brightness value includes the following step:

The gamma module determines the present grayscale value based on the present temperature value, the present brightness value, and a preset lookup table, where the lookup table represents a correspondence between a temperature value, a brightness value, and a grayscale value.

According to a third aspect, an embodiment of this application further provides a computer device. The device includes a processor and a memory.

The memory is configured to store a computer-executable program.

The processor is configured to execute the computer-executable program, to perform the method in any one of the second aspect or the implementations of the second aspect.

According to a fourth aspect, an embodiment of this application further provides a computer-readable storage medium. The computer-readable storage medium stores a computer-executable program. When the computer-executable program is invoked by a computer device, the computer device is enabled to perform the method in any one of the second aspect or the implementations of the second aspect.

### BRIEF DESCRIPTION OF DRAWINGS

FIG. 1 is a diagram of a structure of a display apparatus according to an embodiment of this application;

FIG. 2 is a diagram of a structure of another display apparatus according to an embodiment of this application;

FIG. 3a is a diagram of a function graph according to an embodiment of this application;

FIG. 3b is a diagram of another function graph according to an embodiment of this application;

FIG. 4a is a diagram of another function graph according to an embodiment of this application;

FIG. 4b is a diagram of another function graph according to an embodiment of this application;

FIG. 5a is a diagram of another function graph according to an embodiment of this application;

FIG. 5b is a diagram of another function graph according to an embodiment of this application;

FIG. 6 is a schematic flowchart of a picture adjustment method according to an embodiment of this application;

FIG. 7 is a schematic flowchart of another picture adjustment method according to an embodiment of this application; and

FIG. 8 is a diagram of a structure of a computer device according to an embodiment of this application.

### DESCRIPTION OF EMBODIMENTS

To make objectives, technical solutions, and advantages of this application clearer, the following clearly and completely describes the technical solutions in embodiments of this application with reference to accompanying drawings in embodiments of this application.

For ease of understanding embodiments of this application, the following first describes terms used in embodiments of this application.

### 1. Color Temperature

The color temperature is a measurement unit indicating a color component included in light. Theoretically, a temperature of a black body is a color presented after the absolute black body is heated from an absolute zero. After being heated, the black body gradually turns from black to red, yellow, and white, and finally emits blue light. When the black body is heated to a specific temperature, a spectral component included in light emitted by the black body is referred to as a color temperature at the temperature.

### 2. Grayscale

A picture may be defined as a two-dimensional function f(x, y). x and y are spatial plane coordinates. On any pair of coordinate axes, a value of f is referred to as an intensity or a grayscale of the picture at this point. The grayscale is a color shade level of an electromagnetic wave radiation intensity of a ground object on a black-and-white picture, and is a scale for dividing spectral characteristics of the ground object.

### 3. Pulse Width Modulation (Pulse Width Modulation, PWM)

Pulse width modulation is an analog control mode. In this modulation scheme, a bias of a base of a transistor or a gate of a metal-oxide-semiconductor field-effect transistor is modulated based on a change of a corresponding load, to change a conduction time, so as to change an output of a switching regulated power supply.

Generally, brightness adjustment of a display apparatus mainly includes direct current adjustment and PWM adjustment. Compared with direct current adjustment, brightness adjustment in a PWM dimming mode does not rely on changing input power, but adjusts a duty cycle, to improve viewing brightness of naked eyes through alternate on and off of a screen.

Currently, compared with a conventional liquid crystal display (LCD) and an inorganic gallium nitride and gallium phosphide light-emitting diode display, a micro light-emitting diode (Micro LED) display has advantages such as high contrast, high brightness, a wide color gamut, and a high refresh rate. In addition, compared with an organic light-emitting diode display (AMOLED), the micro LED display has advantages such as high brightness and a long service life. Therefore, the micro LED display is considered as an ultimate display technology, and may be used in a plurality of display forms such as a large-screen television, a medium-sized laptop computer, a monitor, a small-sized mobile phone, and micro-sized augmented reality and virtual reality displaying, especially in the field of wearable augmented reality displaying.

However, due to ordered arrangement of crystal of an inorganic material, lattice constants of different types of crystal structures are different, resulting in a crystal stress, namely, a lattice stress. Under impact of the lattice stress, a larger drive current indicates a blue shift of a light emission peak of the LED, that is, movement of a light emission wavelength of the LED toward a short wavelength direction; and a higher temperature indicates a red shift of the light emission peak of the LED, that is, movement of the light emission wavelength of the LED toward a long wavelength direction. Further, the light emission peak of the LED changes with the drive current and the temperature, resulting in a large color temperature change of color displaying, and affecting viewing experience of a user.

Therefore, how to reduce the color temperature change and improve display picture consistency is an urgent problem to be resolved currently.

For the foregoing problems, embodiments of this application provide a display apparatus, a picture adjustment method, and a device, to resolve problems of a large color temperature change of a display picture and poor display picture consistency.

The following describes a display apparatus provided in example implementations of this application with reference to the foregoing described application scenario and accompanying drawings. It should be noted that the foregoing application scenario is merely shown for ease of understanding the spirit and principle of this application, and an implementation of this application is not limited in this aspect.

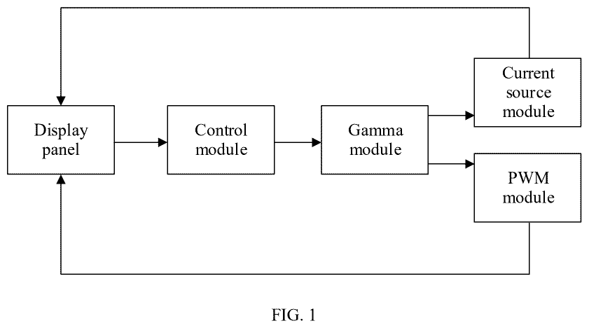

FIG. 1 is a diagram of a structure of a display apparatus according to an embodiment of this application. As shown in FIG. 1, the display apparatus provided in this embodiment of this application includes a display panel, a control module, a gamma module, a current source module, and a pulse width modulation PWM module. Functions of the modules are as follows:

The control module is configured to send panel information of the display panel to the gamma module.

It should be noted that the panel information includes a present temperature value, a present current value, and a present brightness value.

The gamma module is configured to: calculate a target current value based on the present current value and the present temperature value, and send the target current value to the current source module; determine a present grayscale value based on the present temperature value and the present brightness value; and calculate a target grayscale value based on the present grayscale value and the present temperature value, and send the target grayscale value to the PWM module.

The current source module is configured to output a current to the display panel based on the target current value.

The PWM module is configured to output a PWM signal to the display panel based on the target grayscale value.

It should be noted that a reason for a color temperature change of a display picture mainly includes two aspects: a color temperature change caused by a brightness change of the display picture, and a color temperature change caused by a light emission wavelength change of a light-emitting diode.

The display apparatus disclosed in this application corrects the grayscale by adjusting a duty cycle based on the PWM signal, to maintain stability of brightness of the display picture and reduce impact of a temperature change on the brightness of the picture; and corrects the wavelength by driving light emitting of the light-emitting diode via the current, to maintain stability of the light emission wavelength and reduce impact of the temperature change on the light emission wavelength. In conclusion, the display apparatus disclosed in this application can mitigate the color temperature change phenomenon of the display panel caused by the temperature change, and improve display picture consistency.

The following further describes a structure of the display apparatus and functions of components of the display apparatus.

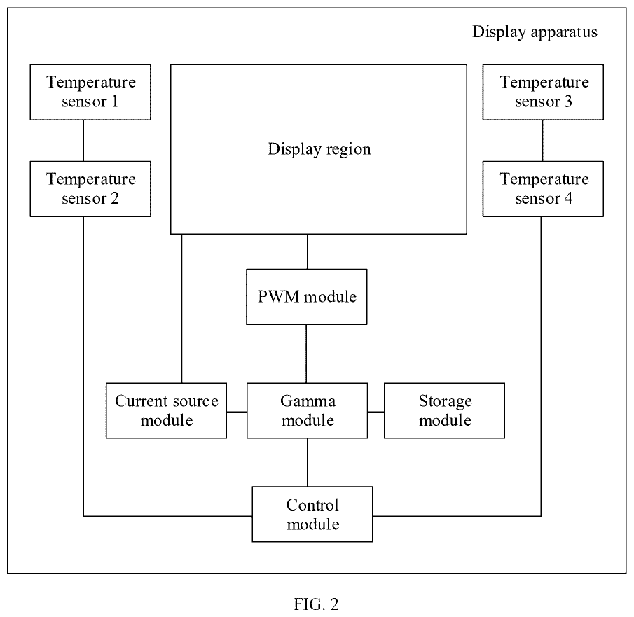

In an implementation, as shown in FIG. 2, based on the display apparatus shown in FIG. 1, the display apparatus may further include at least one temperature sensor (a mounting position of the temperature sensor and a quantity of temperature sensors may be set based on a user requirement, this is not limited in this application, and in FIG. 2, four temperature sensors are used as an example, and are represented by temperature sensors 1 to 4), a storage module, and a display region of the display panel.

Each temperature sensor is configured to obtain real-time temperature information of a chip in the display apparatus, and send the real-time temperature information to the control module.

It should be noted that, because the four temperature sensors are used in the embodiment shown in FIG. 2, the control module may perform averaging processing on a plurality of pieces of real-time temperature information received at a same moment, to obtain an average temperature value, namely, a present temperature value.

The control module may perform averaging processing according to an averaging algorithm or a weighted averaging algorithm. This is not limited in this application. The control module is configured to send the present temperature value, a present current value, and a present brightness value to the gamma module.

It should be noted that the present brightness value may be real-time data of a display brightness value (DVB), where the display brightness value represents a display brightness level. For example, the display apparatus like a mobile phone or a computer usually includes a brightness adjustment button, and a user changes an input display brightness level via the brightness adjustment button, where the display brightness level is the display brightness value.

The control module is further configured to: send a first correction instruction to the gamma module, to instruct to perform compensation correction or gain correction on the present current value of the display panel; and/or send a second correction instruction to the gamma module, to instruct to perform compensation correction or gain correction on a present grayscale value of the display panel.

The storage module is configured to store a preset lookup table, for the gamma module to invoke.

It should be noted that the lookup table represents a correspondence between a temperature value, a brightness value, and a grayscale value.

The gamma module is configured to: invoke the lookup table in the storage module, and substitute the present temperature value and the present brightness value into the lookup table, to determine the present grayscale value.

The gamma module is further configured to: calculate a target current value based on the present current value, the first correction instruction, and the present temperature value, and send the target current value to the current source module.

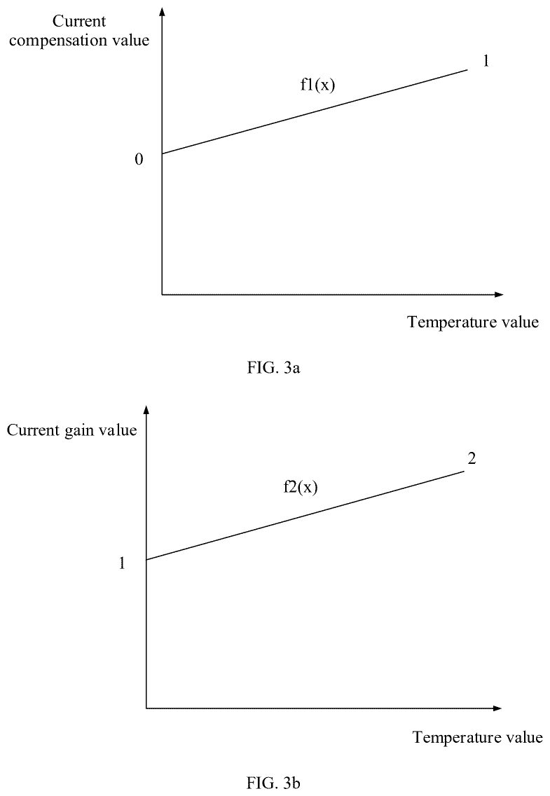

In a possible embodiment, if the first correction instruction instructs to perform compensation correction on the present current value of the display panel, the gamma module calculates a target current compensation value based on the present temperature value and a preset linear function relationship between a temperature value and a current compensation value. For example, the linear function relationship between a temperature value and a current compensation value is shown in FIG. 3a, where a horizontal axis represents a temperature value, a vertical axis represents a current compensation value, there is a linear function f1(x) between the temperature value and the current compensation value, and the current compensation value increases from 0 to 1 as the temperature value increases.

Further, the gamma module adds the present current value to the target current compensation value to obtain the target current value.

In another possible embodiment, if the first correction instruction instructs to perform gain correction on the present current value of the display panel, the gamma module calculates a target current gain value based on the present temperature value and a preset linear function relationship between a temperature value and a current compensation value. For example, the linear function relationship between a temperature value and a current gain value is shown in FIG. 3b, where a horizontal axis represents a temperature value, a vertical axis represents a current gain value, there is a linear function f2(x) between the temperature value and the current gain value, and the current gain value increases from 1 to 2 as the temperature value increases.

Further, the gamma module multiplies the present current value by the target current gain value to obtain the target current value.

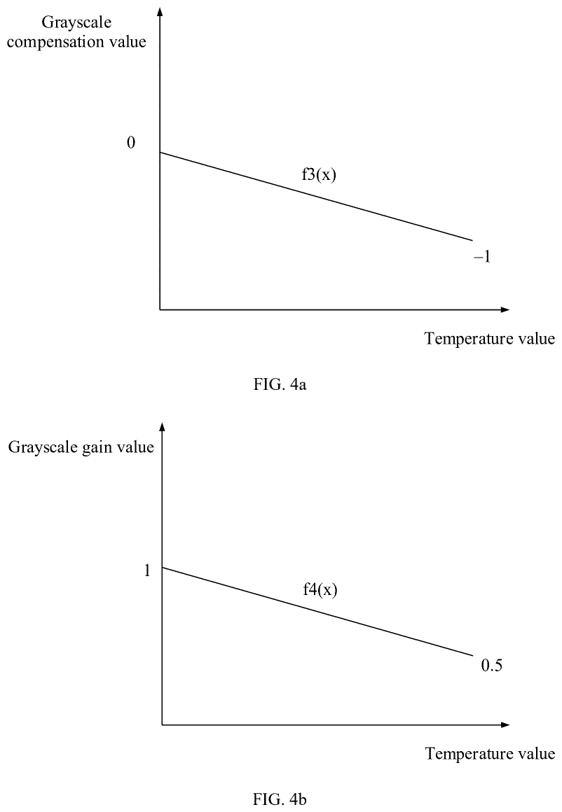

In another possible embodiment, if the second correction instruction instructs to perform compensation correction on the present grayscale value of the display panel, the gamma module calculates a target grayscale compensation value based on the present temperature value and a preset linear function relationship between a temperature value and a grayscale compensation value. For example, the linear function relationship between a temperature value and a grayscale compensation value is shown in FIG. 4a, where a horizontal axis represents a temperature value, a vertical axis represents a grayscale compensation value, there is a linear function f3(x) between the temperature value and the grayscale compensation value, and the grayscale compensation value decreases from 0 to −1 as the temperature value increases.

Further, the gamma module adds the present grayscale value to the target grayscale compensation value to obtain the target grayscale value. Alternatively,

In another possible embodiment, if the second correction instruction instructs to perform gain correction on the present grayscale value of the display panel, the gamma module calculates a target grayscale gain value based on the present temperature value and a preset linear function relationship between a temperature value and a grayscale gain value. For example, the linear function relationship between a temperature value and a grayscale gain value is shown in FIG. 4b, where a horizontal axis represents a temperature value, a vertical axis represents a grayscale gain value, there is a linear function f4(x) between the temperature value and the grayscale gain value, and the grayscale gain value decreases from 1 to 0.5 as the temperature value increases.

Further, the gamma module multiplies the present grayscale value by the target grayscale gain value to obtain the target grayscale value.

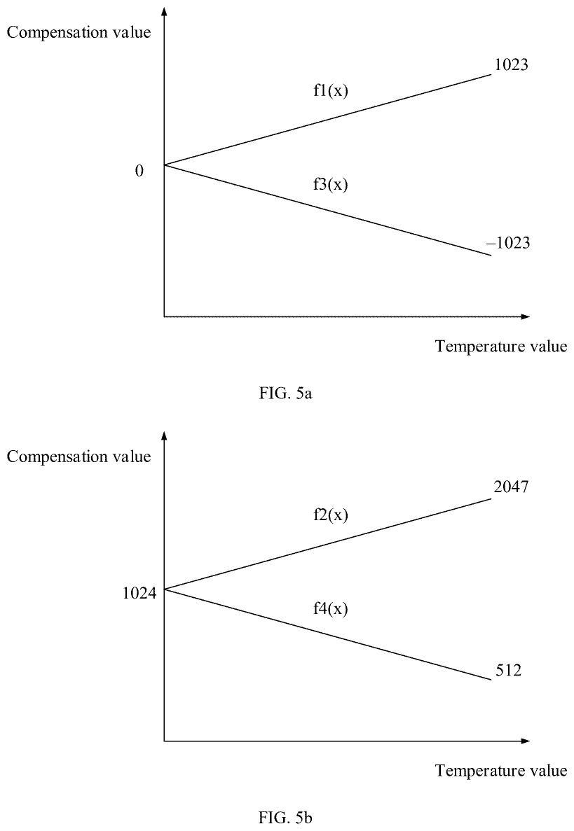

In a possible embodiment, for further intuitive observation and convenience of processing, f1(x) and f3(x) may be combined, and normalization processing is performed, to obtain a function graph shown in FIG. 5a. As the temperature value increases, the current compensation value increases from 0 to 1023, and the grayscale compensation value decreases from 0 to −1023.

In a possible embodiment, for further intuitive observation and convenience of processing, f2(x) and f4(x) may be combined, and normalization processing is performed, to obtain a function graph shown in FIG. 5b. As the temperature value increases, the current gain value increases from 1024 to 2047, and the grayscale gain value decreases from 1024 to 512.

It should be noted that value ranges of the gain values and the compensation values in this application are merely examples. For example, as the temperature value increases, the current compensation value increases from 0 to 5. This is not limited in this application. In addition, a normalization processing method is not limited in this application.

The current source module is configured to output a current to the display panel based on the target current value, to stabilize a light emission wavelength of the light-emitting diode.

The PWM module is configured to output a PWM signal to the display panel based on the target grayscale value, to stabilize light-emitting brightness of the display picture.

In conclusion, according to the foregoing display apparatus, adjustment of a drive current of the display panel can approach linear adjustment, to improve a wavelength change caused by a temperature change. In addition, adjustment of a display grayscale of the display panel can approach linear adjustment, to improve a brightness change caused by the temperature change. In addition, the foregoing display apparatus may further perform gain correction or compensation correction on the drive current and the display grayscale of the display panel based on an actual requirement of the user, to make a correction operation flexible and convenient.

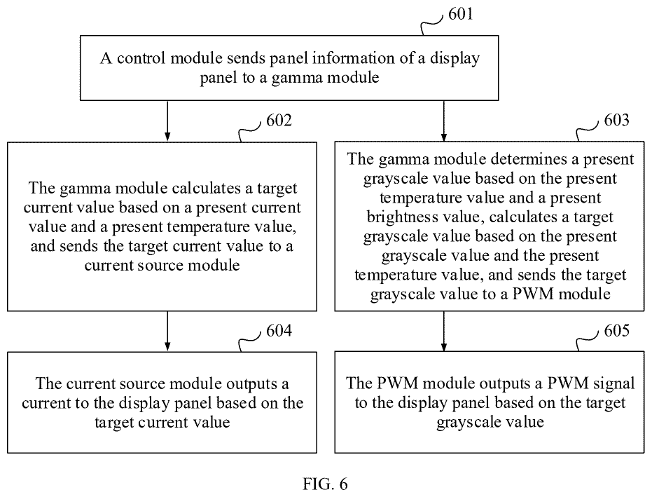

Based on a same technical concept, an embodiment of this application further provides a picture adjustment method, applied to a display apparatus. The display apparatus includes a display panel, a control module, a gamma module, a current source module, and a PWM module. As shown in FIG. 6, the method includes the following steps.

Step 601: The control module sends panel information of the display panel to the gamma module, to perform step 602 and step 603.

It should be noted that the panel information includes a present temperature value, a present current value, and a present brightness value.

Step 602: The gamma module calculates a target current value based on the present current value and the present temperature value, and sends the target current value to the current source module, to perform step 604.

Step 603: The gamma module determines a present grayscale value based on the present temperature value and the present brightness value, calculates a target grayscale value based on the present grayscale value and the present temperature value, and sends the target grayscale value to the PWM module, to perform step 605.

Step 604: The current source module outputs a current to the display panel based on the target current value.

Step 605: The PWM module outputs a PWM signal to the display panel based on the target grayscale value.

The following describes the picture adjustment method in detail.

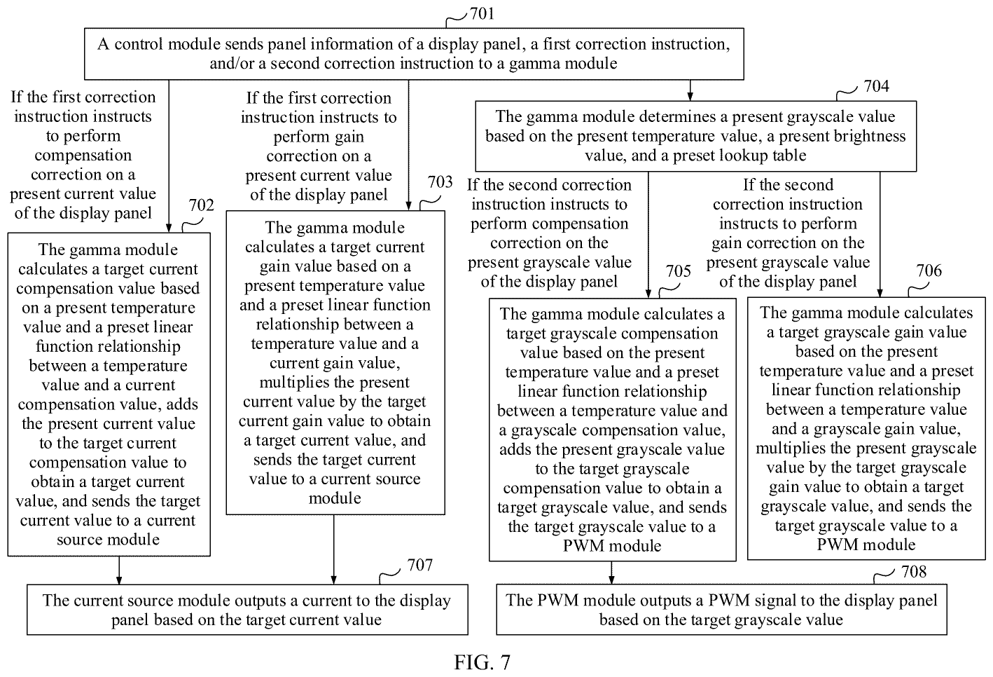

As shown in FIG. 7, the picture adjustment method includes the following steps.

Step 701: The control module sends panel information of the display panel, a first correction instruction, and/or a second correction instruction to the gamma module, to perform step 704. In addition, if the first correction instruction instructs to perform compensation correction on a present current value of the display panel, step 702 is performed; or if the first correction instruction instructs to perform gain correction on a present current value of the display panel, step 703 is performed.

Step 702: The gamma module calculates a target current compensation value based on a present temperature value and a preset linear function relationship between a temperature value and a current compensation value, adds the present current value to the target current compensation value to obtain a target current value, and sends the target current value to the current source module, to perform step 707.

Step 703: The gamma module calculates a target current gain value based on a present temperature value and a preset linear function relationship between a temperature value and a current gain value, multiplies the present current value by the target current gain value to obtain a target current value, and sends the target current value to the current source module, to perform step 707.

Step 704: The gamma module determines a present grayscale value based on the present temperature value, a present brightness value, and a preset lookup table. If the second correction instruction instructs to perform compensation correction on the present grayscale value of the display panel, step 705 is performed; or if the second correction instruction instructs to perform gain correction on the present grayscale value of the display panel, step 706 is performed.

It should be noted that the lookup table represents a correspondence between a temperature value, a brightness value, and a grayscale value.

Step 705: The gamma module calculates a target grayscale compensation value based on the present temperature value and a preset linear function relationship between a temperature value and a grayscale compensation value, adds the present grayscale value to the target grayscale compensation value to obtain a target grayscale value, and sends the target grayscale value to the PWM module, to perform step 708.

Step 706: The gamma module calculates a target grayscale gain value based on the present temperature value and a preset linear function relationship between a temperature value and a grayscale gain value, multiplies the present grayscale value by the target grayscale gain value to obtain a target grayscale value, and sends the target grayscale value to the PWM module, to perform step 708.

Step 707: The current source module outputs a current to the display panel based on the target current value.

Step 708: The PWM module outputs a PWM signal to the display panel based on the target grayscale value.

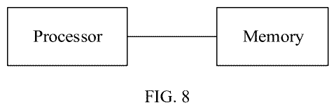

Based on a same technical concept, an embodiment of this application further provides a computer device. As shown in FIG. 8, the device includes a processor and a memory.

The memory is configured to store a computer-executable program.

The processor is configured to execute the computer-executable program, to perform the picture adjustment method shown in FIG. 6 or FIG. 7.

For example, the processor may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be understood that the memory mentioned in embodiments of this application may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) that is used as an external cache. By way of example not limitative description, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

It should be noted that when the processor is a general-purpose processor, a DSP, an ASIC, an FPGA or another programmable logic device, a discrete gate or a transistor logic device, or a discrete hardware component, the memory (a storage module) may be integrated in the processor.

It should be noted that the memory described in this specification aims to include but is not limited to these memories and any memory of another proper type.

Based on a same technical concept, an embodiment of this application further provides a computer storage medium, including a program or instructions. When the program or the instructions are run on a computer, the picture adjustment method shown in FIG. 6 or FIG. 7 is performed.

It should be understood that all related content of the steps in the foregoing method embodiments may be referenced to function descriptions of corresponding functional modules, and details are not described herein again.

A person skilled in the art should understand that embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, a CD-ROM, and an optical memory) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions may be stored in a computer-readable memory that can instruct the computer or another programmable data processing device to operate in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

It is clear that a person skilled in the art can make various modifications and variations to this application without departing from the protection scope of this application. This application is intended to cover these modifications and variations of this application provided that they fall within the scope of protection defined by the claims and their equivalent technologies.

What is claimed is:

1. A display apparatus comprising:
a display panel, a control module, a gamma module, a current source module, and a pulse width modulation (PWM) module;
wherein the control module is configured to send panel information of the display panel to the gamma module, wherein the panel information comprises a present temperature value, a present current value, and a present brightness value;
wherein the gamma module is configured to:
determine a target current value based on the present current value and the present temperature value and send the target current value to the current source module;
determine a present grayscale value based on the present temperature value and the present brightness value; and
determine a target grayscale value based on the present grayscale value and the present temperature value and send the target grayscale value to the PWM module;
wherein the current source module is configured to output a current to the display panel based on the target current value; and
wherein the PWM module is configured to output a PWM signal to the display panel based on the target grayscale value.

2. The apparatus according to claim 1, wherein the control module is further configured to send a first correction instruction to the gamma module, to instruct to perform compensation correction or gain correction on the present current value of the display panel; and
the gamma module is further configured to:
based on the first correction instruction instructing to perform compensation correction on the present current value of the display panel, determine a target current compensation value based on the present temperature value and a preset linear function relationship between a temperature value and a current compensation value, and add the present current value to the target current compensation value to obtain the target current value; or
based on the first correction instruction instructing to perform gain correction on the present current value of the display panel, determine a target current gain value based on the present temperature value and a preset linear function relationship between a temperature value and a current gain value, and multiply the present current value by the target current gain value to obtain the target current value.

3. The apparatus according to claim 1, wherein the control module is further configured to:
send a second correction instruction to the gamma module, to instruct to perform compensation correction or gain correction on the present grayscale value of the display panel; and
the gamma module is further configured to:
based on the second correction instruction instructing to perform compensation correction on the present grayscale value of the display panel, determine a target grayscale compensation value based on the present temperature value and a preset linear function relationship between a temperature value and a grayscale compensation value, and add the present grayscale value to the target grayscale compensation value to obtain the target grayscale value; or
based on the second correction instruction instructing to perform gain correction on the present grayscale value of the display panel, determine a target grayscale gain value based on the present temperature value and a preset linear function relationship between a temperature value and a grayscale gain value, and multiply the present grayscale value by the target grayscale gain value to obtain the target grayscale value.

4. The apparatus according to claim 1, wherein the gamma module is further configured to determine the present grayscale value based on the present temperature value, the present brightness value, and a preset lookup table,
wherein the lookup table represents an association among a temperature value, a brightness value, and a grayscale value.

5. A picture adjustment method applied to a display apparatus comprising a display panel, a control module, a gamma module, a current source module, and a pulse width modulation (PWM) module, the picture adjustment method comprising:
sending, by the control module, panel information of the display panel to the gamma module, wherein the panel information comprises a present temperature value, a present current value, and a present brightness value;
determining, by the gamma module, a target current value based on the present current value and the present temperature value, and sending the target current value to the current source module;
determining, by the gamma module, a present grayscale value based on the present temperature value and the present brightness value;
determining, by the gamma module, a target grayscale value based on the present grayscale value and the present temperature value, and sending the target grayscale value to the PWM module;
outputting, by the current source module, a current to the display panel based on the target current value; and
outputting, by the PWM module, a PWM signal to the display panel based on the target grayscale value.

6. The method according to claim 5, wherein the method further comprises:
sending, by the control module, a first correction instruction to the gamma module, to instruct to perform compensation correction or gain correction on the present current value of the display panel; and
determining, by the gamma module, the target current value based on the present current value and the present temperature value comprises:
based on the first correction instruction instructing to perform compensation correction on the present current value of the display panel, determining, by the gamma module, a target current compensation value based on the present temperature value and a preset linear function relationship between a temperature value and a current compensation value, and adding the present current value to the target current compensation value to obtain the target current value; or
based on the first correction instruction instructing to perform gain correction on the present current value of the display panel, determining, by the gamma module, a target current gain value based on the present temperature value and a preset linear function relationship between a temperature value and a current compensation value, and multiplying the present current value by the target current gain value to obtain the target current value.

7. The method according to claim 6, wherein the method further comprises:
sending, by the control module, a second correction instruction to the gamma module, to instruct to perform compensation correction or gain correction on the present grayscale value of the display panel; and
based on the second correction instruction instructing to perform compensation correction on the present grayscale value of the display panel, determine, by the gamma module, a target grayscale compensation value based on the present temperature value and a preset linear function relationship between a temperature value and a grayscale compensation value, and adding the present grayscale value to the target grayscale compensation value to obtain the target grayscale value; or
based on the second correction instruction instructing to perform gain correction on the present grayscale value of the display panel, determining, by the gamma module, a target grayscale gain value based on the present temperature value and a preset linear function relationship between a temperature value and a grayscale gain value, and multiplying the present grayscale value by the target grayscale gain value to obtain the target grayscale value.

8. The method according to claim 5, wherein determining the present grayscale value based on the present temperature value and the present brightness value comprises:
determining, by the gamma module, the present grayscale value based on the present temperature value, the present brightness value, and a preset lookup table, wherein the lookup table represents a correspondence between a temperature value, a brightness value, and a grayscale value.

9. A computer device comprising:
a processor and a memory, wherein the memory is configured to store a computer-executable program, and wherein the processor is configured to execute the computer-executable program to perform a method applied to a display apparatus comprising a display panel, a control module, a gamma module, a current source module, and a pulse width modulation (PWM) module, wherein the method comprises:
sending, by the control module, panel information of the display panel to the gamma module, wherein the panel information comprises a present temperature value, a present current value, and a present brightness value;
determining, by the gamma module, a target current value based on the present current value and the present temperature value, and sending the target current value to the current source module;
determining, by the gamma module, a present grayscale value based on the present temperature value and the present brightness value;
determining, by the gamma module, a target grayscale value based on the present grayscale value and the present temperature value, and sending the target grayscale value to the PWM module;
outputting, by the current source module, a current to the display panel based on the target current value; and
outputting, by the PWM module, a PWM signal to the display panel based on the target grayscale value.
